(19) United States
(12) Patent Application Publication
(10) Pub. No.: US 2025/0385884 A1
(43) Pub. Date: Dec. 18, 2025

(54) Automatic Electronic Message Recipient Assignment Optimization

(71) Applicant: Klaviyo, Inc., Boston, MA (US)

(72) Inventors: Ian Delbridge, Cambridge, MA (US); Carola Leiva, Brookline, MA (US); Thomas Dinitz, Pasadena, CA (US); Lilia Staszel, Cambridge, MA (US)

(21) Appl. No.: 18/746,233

(22) Filed: Jun. 18, 2024

(51) Int. Cl. H04L 51/214; H04L 51/18

(52) U.S. Cl. CPC H04L 51/214; H04L 51/18

(57) ABSTRACT

A method for optimally assigning recipients to electronic messages that vary by content. The method comprises testing the varying electronic messages on test recipients for a target behavior and computing a metric corresponding to the target behavior of the recipients. The method further comprises building a recipient assignment model to predict the likelihood a recipient shall perform the target behavior after receiving the varying electronic messages. Untested recipients are then assigned to one of the electronic messages using the model to maximize the likelihood the recipient shall perform the target behavior. The method further comprises sending to each of the untested recipients the optimal variation of electronic message. Related systems are also described.

### TECHNICAL FIELD

This generally relates to electronic messaging, and more particularly, to adaptively assigning recipients to different electronic message templates.

### BACKGROUND

Electronic messaging modalities such as email and SMS are regularly used to deliver a wide range of information from a user to a recipient. It is not uncommon for a user to send bulk electronic messages to multiple recipients (e.g., 1000 or more). However, no one type of electronic message template is optimally engaging to all recipients. To solve this challenge, users segment the recipients “by hand” using simple logic rules and the user's intuition to send different electronic message templates to different recipient segments to try to achieve better results than that arising from a “one-size-fits-all” electronic messaging scheme.

Applying rules by hand using intuition, however, is slow, clunky, and prone to errors in judgment. This is undesirable.

Accordingly, a method and system that addresses the above-mentioned challenges is desired.

### SUMMARY OF THE INVENTION

Described herein are systems for autonomically assigning recipients to different electronic message templates in order to maximize the likelihood the recipient shall perform a target behavior.

In embodiments, a system comprises a plurality of different modules implemented on at least one server. A user-configuration module is programmed and operable to receive a plurality of types of electronic messages, a set of recipients, and optimization parameters, wherein the optimization parameters comprise: a time delay for testing, a contextual variable corresponding to the recipients, and a target behavior of the recipient that the user desires to optimize.

A testing module is programmed and operable to: select a sample of recipients from the set of recipients, thereby grouping the recipients into selected recipients and unselected recipients; send electronic messages from the plurality of types of electronic messages to the selected recipients; detect, after the time delay for testing, for the target behavior of the selected recipients; and compute a metric corresponding to the target behavior of the selected recipients based on the detect step. In some embodiments, the testing module is configured to select all recipients for testing in which case the group of unselected recipients is empty.

A build-model module is programmed and operable to build a recipient assignment model based on the computed metric, wherein the recipient assignment model is operable to predict the likelihood a recipient shall perform the target behavior after receiving each of the plurality of types of electronic messages and to determine an optimal type of electronic message for each recipient.

A manage module is programmed and operable to: administer data transfer between the user-configuration, testing, and build-model modules; run the recipient assignment model on the group of unselected recipients to determine an optimal type of electronic message for each of the unselected recipients; and optionally send (or instruct another to send) the optimal type of electronic message to each of the unselected recipients.

In embodiments, the user-configuration module is further operable to receive the sample size for testing.

In embodiments, the metrics comprise total number of clicks on an email link, average dwell time for a message, and message open rates.

In embodiments, the contextual variables include age, gender, geographical location, number of purchases, or average purchase amount.

In embodiments, the at least one server is further programmed and operable to compute default parameters for increasing the likelihood of determining the optimal type of electronic message for each recipient.

In embodiments, the computing comprises use of a lookup table populated with statistics from the recipients or other recipients, a simulation model operable to predict behaviors of the recipients, or an insight rule based on previous historical data or tests from the recipients or other recipients.

In embodiments, the at least one server is further programmed and operable to compute at least one insight rule, indicating a characteristic of the recipients that contributes to the recipient's affinity towards a type of electronic message.

In embodiments, during the compute at least one insight rule, the recipients are partitioned into two subgroups comprising: (a) a first subgroup where an observed preference for a message relative to other messages is maximized and (b) a second subgroup where an observed preference against a message relative to other messages is maximized, then to determine whether the first and second subgroups' preferences are statistically significantly different than an overall group preferences of recipients using a statistical test.

In embodiments, the statistical test is the Breslow Day test.

In embodiments, the insight rules are displayed to the user, and optionally, in an order corresponding to the most statistically significant difference versus an overall group preference.

In embodiments, the at least one server is further programmed and operable to compute: (a) the likelihood that a recipient shall perform a target behavior for a targeted message is greater than the likelihood that a recipient will perform a target behavior for a general message; and (b) the likelihood that a recipient shall perform a target behavior for a targeted message is within a predetermined confidence interval, and wherein the predetermined confidence interval. In embodiments, the predetermined confidence interval corresponds to the likelihood that a recipient shall perform a target behavior for a targeted message at least 90% of the time.

In embodiments, a computer-implemented method for optimizing assignment of electronic message recipients comprises: receiving a plurality of types of electronic messages, a set of message recipients, and optimization parameters, wherein the optimization parameters comprise a time delay, contextual variables corresponding to the recipients, and recipient target behaviors the user desires to optimize.

In embodiments, the method further comprises selecting a sample of recipients from the set of recipients, thereby defining the recipients into selected recipients and unselected recipients.

In embodiments, the method further comprises sending selected electronic messages from the plurality of types of electronic messages to the selected recipients; detecting, after the time delay, for the target behavior of the selected recipients; and computing a metric corresponding to the target behavior of the selected recipients based on the detecting step.

In embodiments, the method further comprises building a recipient assignment model based on the computed metric, wherein the recipient assignment model is operable to predict the likelihood a recipient shall perform the target behavior after receiving each of the plurality of types of electronic messages; running the recipient assignment model on the unselected recipients to determine an optimal type of electronic message for each of the unselected recipients.

In embodiments, the method further comprises sending (or instructing another to send) to each of the unselected recipients an optimal type of electronic message based on running step.

In embodiments, the method further comprises computing a set of defaults for increasing the likelihood of determining the optimal type of electronic message for each recipient.

In embodiments, the computing is performed using a lookup table, a simulation model, or insight rule based on historical data of the user or other users.

In embodiments, the metric comprises click rates, average dwell time, and open rates.

In embodiments, the contextual variable is one selected from the group comprising age, geographical location, or average purchase amount.

In embodiments, the method further comprises computing at least one insight rule, indicating a characteristic of the recipients that contributes to the recipient's affinity towards a type of electronic message.

In embodiments, the method further comprises computing (a) the likelihood that a recipient shall perform a target behavior for a targeted message is greater than the likelihood that a recipient will perform a target behavior for a general message; and optionally, (b) the likelihood that a recipient shall perform a target behavior for a targeted message is within a predetermined confidence interval.

In embodiments, the computing is based on the recipient assignment model.

In embodiments, the recipient assignment model is a decision tree-based model.

In embodiments, the recipient assignment model is an uplift random forest model.

In embodiments, the detecting arises from an integrator server.

In embodiments, the types of electronic messages differ based on content, and

wherein the content is selected from the group comprising subject matter, images, and style.

In embodiments, the electronic messages are sent via a modality of channel selected from the group consisting of email, SMS, and push notification.

In embodiments, the method further comprises dividing the recipients into groups according to an optimal type of electronic message for each recipient, and saving the groups, and any rules used to determine the groups.

In embodiments, the method further comprises providing guidance if the test delay or number of recipients in the set is not sufficient for obtaining a statistically significant confidence that an optimized/assigned recipients will more likely perform a target behavior for a first message than a second (or general) message.

In embodiments, the selecting the sample of recipients and the selecting electronic messages is performed randomly.

In embodiments, the recipient assignment model is a decision tree-based algorithm, optionally, uplift random forest model.

In embodiments, the optimal recipient is determined for each type of electronic message instead of computing the optimal electronic message for all recipients.

### OBJECTS AND ADVANTAGES

Embodiments of the invention have a variety of objects and advantages.

In embodiments, an object is to provide an automatic way to assign recipients to one of several different electronic message templates. Users save effort and assign recipients to the messages in a better, more flexible, and more statistically-backed manner.

In embodiments, an object is to, instead of trying to compute the optimal electronic message for all recipients, the optimal recipient is determined for each type of electronic message.

In embodiments, an object is to save the recipients in groups based on which electronic message a recipient was assigned.

In embodiments, an object is to compute rules and confidence levels thereof corresponding to characteristics of the recipients that contribute to recipients' affinity towards a given message variant. The rules are, in a sense, insight that explain why recipients are assigned to a variation in a way that can be used for later message creation and targeting strategy.

In embodiments, an object is to provide confidence levels that correspond to the likelihood that different messages were better for different recipients.

In embodiments, an object is to provide the users the rules, confidence levels, and assigned recipient groups. Such analytic information can be very useful to the users even without sending the electronic messages to the recipients. Although, as described herein, in embodiments, the electronic messages are sent to the assigned recipients whether by the user or another third party such as an email sender provider (ESP) service.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings in which:

FIG. 1 is a schematic diagram of a system for optimizing assignment of electronic message recipients, according to one or more embodiments of the present invention;

FIG. 2-3 are flowcharts illustrating an overview of a process for optimizing assignment of electronic message recipients, according to one or more embodiments of the present invention;

FIG. 4 is a more detailed flowchart of a process for optimizing assignment of electronic message recipients, according to one or more embodiments of the present invention;

FIG. 5 is a flowchart of a process for computing rules to identify, rank, and present rules corresponding to characteristics of the recipients that contribute to recipients' affinity towards a given message variant, according to one or more embodiments of the present invention;

FIG. 6 is a flowchart of a process for computing statistical significance for metrics corresponding to the optimized recipients, according to one or more embodiments of the present invention;

FIGS. 7-10 are flowcharts of processes for determining inputs for testing, according to one or more embodiments of the present invention;

FIG. 11 is a flowchart of a process for sending optimized electronic messages to optimized recipients, according to one or more embodiments of the present invention; and

FIG. 12 is a flowchart of a decision tree model for optimizing recipient assignments, according to one or more embodiments of the present invention.

### DETAILED DESCRIPTION

Before the present invention is described in greater detail, it is to be understood that this invention is not limited to particular embodiments described, and as such can, of course, vary. It is also to be understood that the terminology used herein is for the purpose of describing particular embodiments only, and is not intended to be limiting, since the scope of the present invention will be limited only by the appended claims. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described. It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation. As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

All existing subject matter mentioned herein (e.g., publications, patents, patent applications and hardware) is incorporated by reference herein in its entirety except insofar as the subject matter may conflict with that of the present invention (in which case what is present herein shall prevail).

US Patent Publication 2023/0413020A1, filed Oct. 30, 2022, to Lawson et al. is incorporated by reference in its entirety for all purposes.

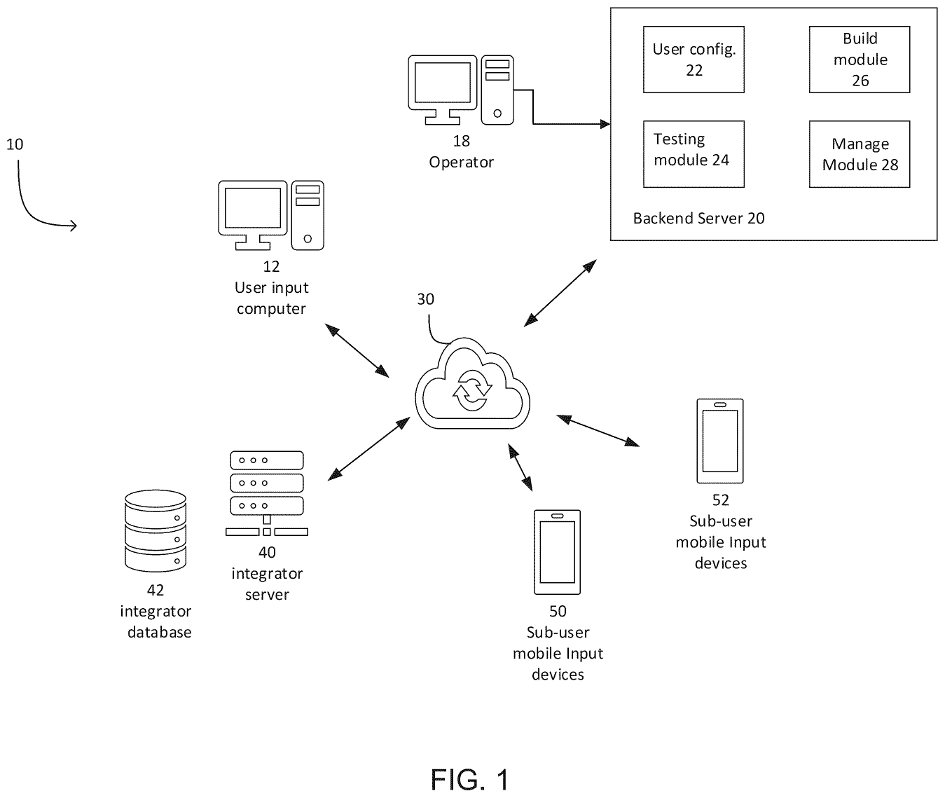

FIG. 1 is a schematic diagram of a system 10 for optimizing assignment of electronic message recipients, according to one or more embodiments of the present invention. The system 10 is shown including a user input computer 12, a backend server 20 managed by an operator 18, and a plurality of sub-user mobile input devices 50, 52. Optionally, an integrator server/database 40, 42 is operable to host the user's website and monitor behaviors of the sub-users. In some embodiments, the user 12 is a merchant selling products or services to the sub-users 50, 52 through a website operated by the integrator 40 (e.g., Shopify). When the user desires to send electronic messages to the optimal sub-users 50, 52, the user can make a request to the backend server. Backend server 20 then computes the optimal sub-users (namely, recipients) for each content-type (or template) of electronic message. Instead of trying to compute the optimal content-type of electronic message for all recipients, embodiments of the present invention compute the optimal recipient for each content-type of electronic message.

With reference again to FIG. 1, the backend server 20 is shown having a configuration module 22, electronic message testing module 24, recipient assignment model build module 26, and manage module 28 for generally administering the server and the data between the different modules. Each of these functional modules are described herein in connection with various methods for assigning optimized recipients to the content-differing electronic messages.

Also, although FIG. 1 refers to sub-user mobile input devices, the invention is not intended to be so limited. The invention is also applicable to non-mobile-type sub-user input devices including, e.g., a desktop computer.

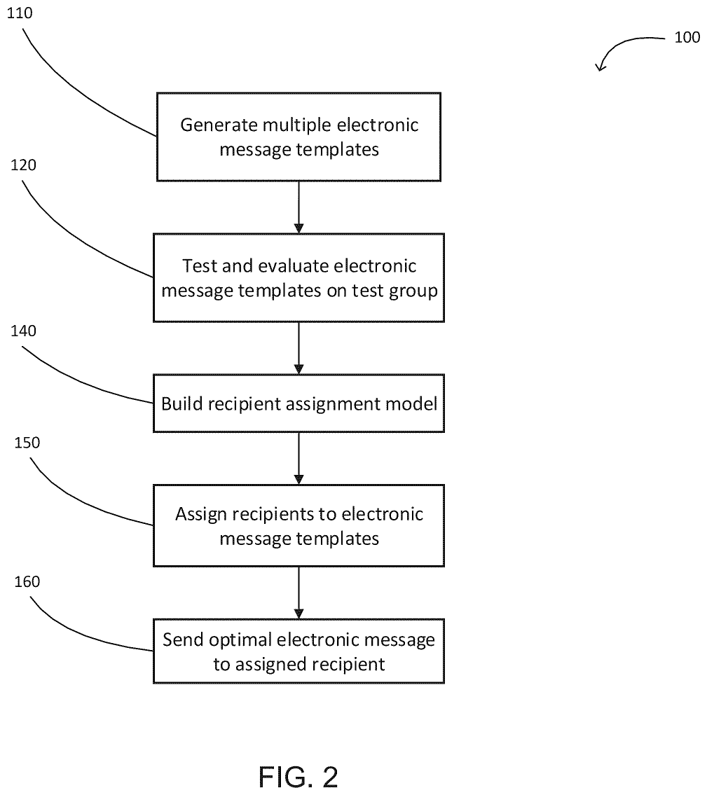

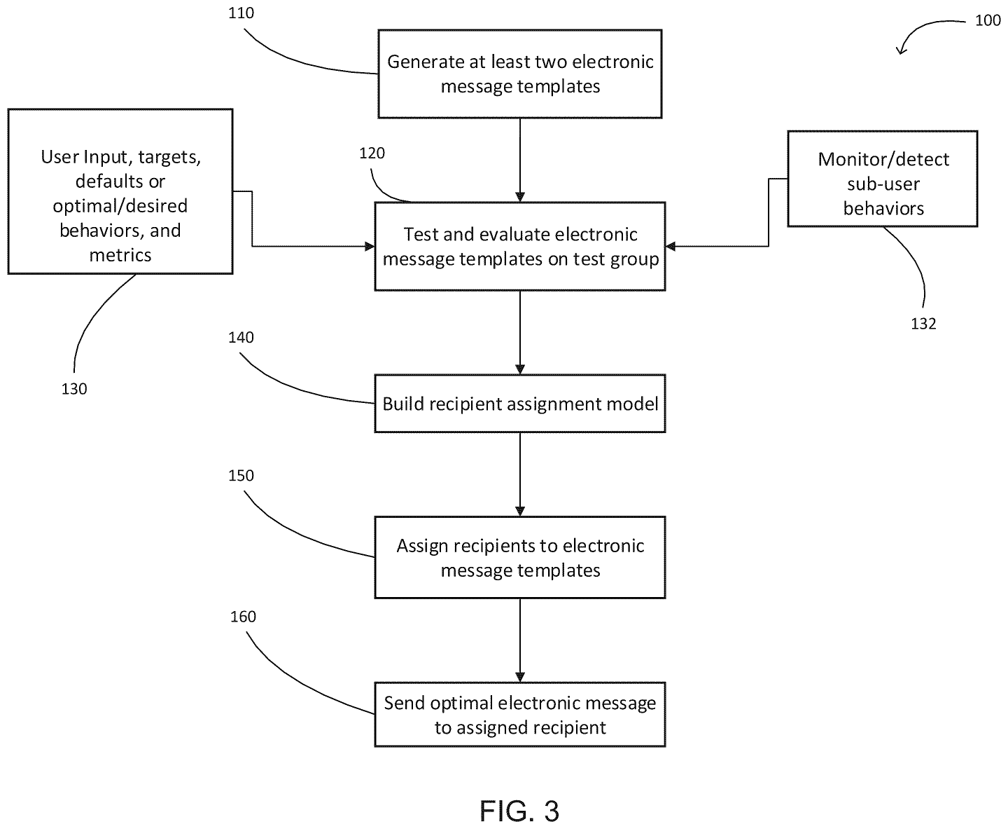

FIG. 2-3 are flowcharts illustrating an overview of a process 100 for optimizing assignment of electronic message recipients, according to one or more embodiments of the present invention.

Step 110 states to generate multiple electronic message templates. In embodiments, this step is performed by the user input computer 12 or a third-party server to create at least two electronic message templates each having different content or optionally, different send times (e.g., an A template and a B template). Non-limiting examples of content are text size, color, images, graphics, formatting, etc. Additionally, in some embodiments, the first template and the second template further include different displays. That is, messages associated with the first template and the second template display messages in varying ways. Additionally, and although described here as the generation of a first template and a second template, it is to be understood that the computing device or server can generate N templates that include the first template and a second template.

For an embodiment, each of the N templates includes a set of data objects that combine to represent a structure of an electronic message. As described, the first and second templates of the N templates of the message each have a different content, a different send time, and/or a different behavior. The different displays of the message can include a changing display, such as movement or varying display intensity. Accordingly, the set of data objects of each of the first and second templates combine to represent a structure of message having a different content, different send times, or different behavior of the messages. For an embodiment, the structure of the message includes the content, the send time, or the behavior control.

Step 120 states to test and evaluate electronic message templates on test group (sometimes referred to herein as an “A/B test”). As described further herein, in embodiments, this step is performed by the backend server by sending selected electronic templates from the step 110 to a test group of recipients and to detect for a target behavior (e.g., clicks, opens, or purchases) of the selected recipients; and compute a metric corresponding to the target behavior (e.g., click rate, open rate, and purchase rate). Optionally, the selection of the templates and recipients is performed automatically by the server by random selection, quasi-random, stratified sampling, or stochastic model-based matching methods.

Step 140 states to build recipient assignment model. This step is performed by the backend server by generating a model based on the metric computed in step 120.

In embodiments, a decision tree-based model is trained or fitted to the testing data arising from step 120, discussed further herein. In embodiments, a recipient type is associated with the particular message template according to a score or statistical significance, as described herein.

Step 150 states to assign recipients to electronic message templates. This step is performed by the backend server 20 where the hold-out recipients (i.e., the recipients excluded from the test group) are assigned to the different types of electronic messages as computed by the recipient assignment model from step 140. Optionally, the recipients can be stored in groups according to which message they were assigned.

Step 160 states to send the optimal electronic message to the assigned recipient. This step can be performed by the backend server, the integrator, the user or another third party such as a bulk email sender. In embodiments, this step sends each type of electronic message to the recipients assigned to it from the step 150.

FIG. 3 is another flowchart of the process 100 shown in FIG. 2, and further includes inputs 130, 132.

In particular, step 130 lists user input, targets, defaults or optimal desired behaviors, and metrics. This information can be provided via the user input computing device 12 or otherwise as the case may be.

Examples of user input include test size (namely, the number of recipients to be tested) and time delay (namely, the test duration before sending the electronic messages to the unselected recipients or holdout group).

Examples of properties or actions of the recipients the user desires to use for optimization include, without limitation, gender, age, geography, email domain, SMS carrier, custom user-defined properties relevant to the user's messages (such as “favorite color”, “skin type”, “primary sport”, etc.), predictive properties (such as customer lifetime value, discount affinity, predicted buying consideration stage), time since joining the user's mailing list, descriptors of products purchased or browsed, average order value, and interactions with past messages. In addition, inferred latent representations or embeddings of products the sub-user is interested in or of the sub-user's observed as a whole may be similarly used for optimization.

Examples of sub-user behavior for which the user desires to optimize include, without limitation, clicks, opens, form submits, visits to the user's website (“active on site”), and purchases.

Examples of metrics to optimize include, without limitation, click rates, open rates, form submit rates, “active on site” rates, average purchase revenue, and purchase rates.

Additionally, for an embodiment, the server operates to determine information associated with the electronic message which can be used as input for testing. For an embodiment, the information associated with the electronic message is at least partially generated automatically.

For an embodiment, the information is stored in a database that is accessible by the server and includes information pertaining to the user computing device 12 (operated by, e.g., a merchant of the marketing manager) and sub-user mobile input devices 50, 52 that can be operated by customers of the merchant. For example, the information pertaining to the user may include countries the user has a subscription to send mobile messages, a remaining mobile message sending balance, and/or mobile message recipients of the user. This information can be populated, for example, by the subscription to list events or changes to the user's subscription plan.

For various embodiments, the information associated with the message includes message content and a send time (which can be user-generated).

For an embodiment, the information associated with the mobile message includes geolocation information. For example, the geolocation information of a cell carrier that operates to send the mobile message. For an embodiment, the geolocation of a cell carrier is automatically generated. For an embodiment, the geolocation of the mobile message recipient is inferred from information from the cell carrier. For an embodiment, the geolocation of the cell carrier (Verizon USA® or Verizon Canada®) is utilized and may be used to infer the geolocation of the mobile recipient. For an embodiment, the geolocation of the user (account of) is also used and may factored into the guidance provided to the user.

For an embodiment, the information associated with the mobile message includes a size of an electronic campaign that the mobile message is associated. This information can be automatically generated or can be user generated. For an embodiment, the user 12 specifies a list of mobile message recipients the user wants to include and exclude from a campaign, then, for an embodiment, the server automatically determines the size of the campaign based on those criteria.

For an embodiment, the information associated with the mobile message includes a rate of message sending available to a user of an electronic campaign of the mobile message per geographical region (that is, for example, country). For an embodiment, this information is generated automatically, but at least partially determined by the subscription plan of the user and a sending number type (for example, toll free versus short code versus alphanumeric.

For an embodiment, the information associated with the mobile message includes legal restrictions in selected regions in which the mobile message is to be sent. For an embodiment, this information is generated automatically. The legal restrictions include, for example, send times, option to unsubscribe, sender self-identification, and message content (e.g. SHAFT (Sex, Hate, Alcohol, Firearms, Tobacco) restrictions).

For an embodiment, the information associated with the mobile message comprises latency of reported subsequent actions by cellular carriers. For an embodiment, this information is generated automatically. For at least some embodiments, SMS (Short Message Service) sending platforms (for example, Twilio®) have APIs (application programming interfaces) that can be used to retrieve information on whether messages were actually delivered to the intended mobile message recipients. However, there may be bandwidth and latency issues involved here. Relating to bandwidth, the number of mobile messages that can be sent per unit of time has a maximum cap, and for an embodiment, guidance needs to allow enough time for the entire test group (that is, all templates in the test) of the mobile message to be sent and allow enough time to pass for the analytics relevant to the test period to accrue. Relating to latency, the carriers have delays of differing length in how quickly the carriers report analytics, which introduces delays for obtaining analytics relevant to the test period (that is, analytics used to determine the winner of the test).

For an embodiment, the information associated with the mobile message include platform-wide event rates and latency. For an embodiment, this information is generated automatically, but based on monitoring actions by users (e.g., one or more users 12) by the operator of the server, and mobile message recipients. For an embodiment, a suggested length of time for testing of the templates (for example, an A/B test) is based on how quickly click events (actions of the mobile message recipients in response to receiving a mobile message) typically occurs from the time the mobile message is sent.

For an embodiment, the information associated with the mobile message comprises a remaining balance for message sending available to the user. For an embodiment, this information is generated automatically. For an embodiment, this information is user generated. For an embodiment, this information includes a remaining balance (that is, the number of messages the subscription of the user allows the user to send this period that the user has not yet sent) is automatically retrieved at the time of a test creation.

Examples of default optimization parameters include, without limitation, a user's historical inputs, properties, target behavior selections, as well as historical model output including rules and grades for recipients from the user or another user, and described further herein. In embodiments, the default parameters are provided to the user automatically as default values after which the user can modify. In embodiments, if the user does not modify the default parameters, step 120 commences to test and evaluate the electronic messages on the test group based on the default optimization parameters.

For some embodiments, the default parameters are automatically applied to test the test group of recipients and the results are used to automatically build the recipient assignment model. The confidence levels from the model are evaluated for whether they reach a sufficient threshold value. If not, the method returns to step 130 and the user is prompted for additional custom inputs to repeat testing 120, as described herein. On the other hand, if the confidence levels meet the minimum thresholds, the method can proceed to step 150 without modifying the inputs.

In embodiments, the server is programmed to provide a wide range of customization options (e.g., without limitation, options to enter or select inputs and defaults and rules as described herein) for the user. Options can be looked up, computed or otherwise determined by the server and provided to the user via display or GUI or API. In embodiments, the user may configure the server to optimize a wide range of types of server-detected or integration-sent events pertaining to recipients.

Step 132 states to monitor/detect sub-user behaviors. Such actions include, for example, clicks (selection of a link within a received mobile or email message), placing an order, scroll time, and/or a composite of clicks and placed orders. For example, the actions taken can include opening or clicking an email or mobile message, submitting an electronic form, visiting a user's website, or purchasing from the user within the time delay or test duration such as, e.g., 2-8 hours, and in some embodiments six hours. For an embodiment, behaviors to monitor include mobile message recipient(s) carrying out a main action that a mobile or email message is intended to elicit, such as, for example, clicking a link in the message (potentially embedded in an image), or making a purchase on the website linked to the message.

In some embodiments of the invention, sub-user behaviors 50, 52 are detected by third parties or the integrators 40. In some embodiments, the sub-user behaviors are detected/sensed based on the detection of requests of “tracking pixels” (small server-configured images included in an email with recipient-specific asset IDs such that a sub-user opening an email results in a request to the server, and the asset ID can be used to identify the requesting sub-user). Sub-user behaviors may also be detected/sensed based on submission of forms included in an email via integrators or direct to the server. Additionally, sub-user behaviors may be detected/sensed based on link tracking methods such as UTM parameters (URL parameters that identify the message originating the click and therefore identify the sub-user clicking on the link). Sub-users' behaviors may also be detected/sensed based on cookies on the user's website (run on an integrator's servers) which identify which sub-user is active on which page of the website. In some embodiments, geolocation information is monitored based on geolocation information of the computing device. When the sub-user computing device 50, 52 is a mobile phone, e.g., the location can be detected using GPS and input to the testing module.

In some embodiments, the input to the testing is pre-processed for testing. For example, the custom input can be converted into standardized input if a custom input is not in a proper format. For example, if the custom input includes a spelling error, different unit, the server senses the anomaly and can convert it to a standardized format for use in the testing as input. For example, if a location input cannot be recognized, the location may be inferred from other location-related information, like IP address, cell phone tower connectivity, addresses used for online purchases, etc. The location is first cross-referenced with known locations (standardized country codes, for instance). If there is not a match, the next-most-reliable location source that is known is used. For instance, IP address is only used if it is the only remaining location source.

For another example, custom inputs are specified in improper data formats: one's age may be encoded as a string data type. These custom inputs are automatically matched to their proper data types by attempting to convert into each of the major data types (string/categorical, numerical, Boolean, datetime) and accepting the data type that is most successfully converted.

For another example, a large language model (LLM) configured by the server may be used to correct deviations from common input categories.

For another example, an LLM configured by the server may be used to categorize the custom input values into a small number of categories. For example, if the custom input is a sub-user's free-text description of their interests, the LLM may be configured to determine sub-user interest categories and categorize the custom input by those categories.

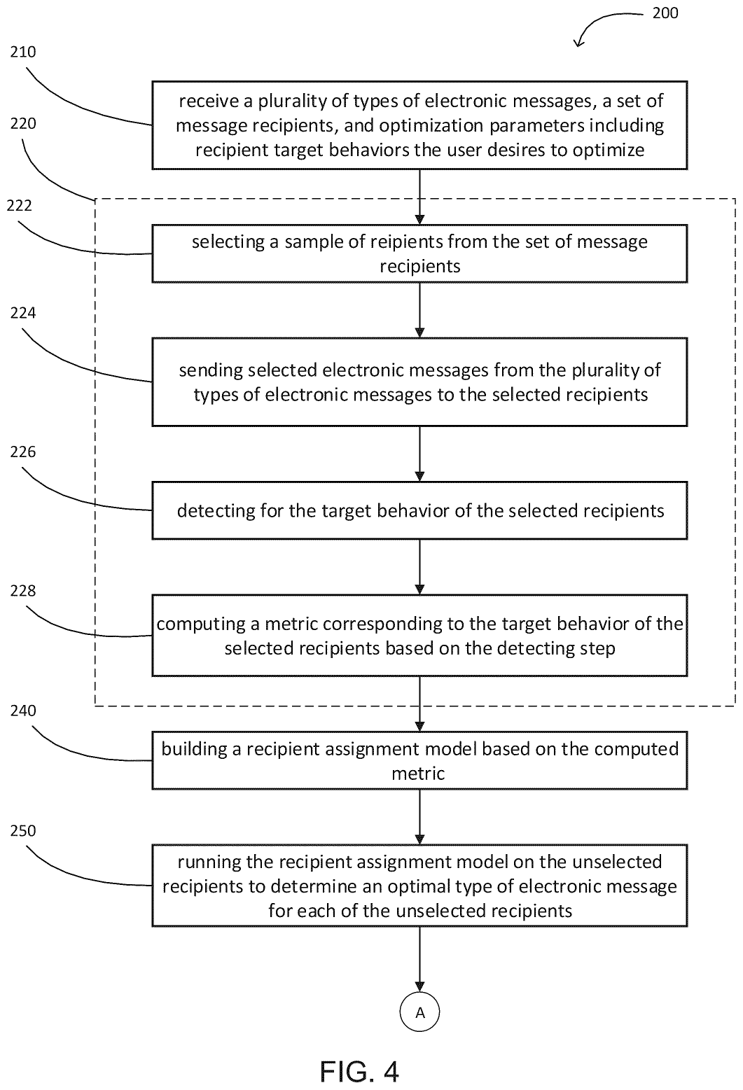

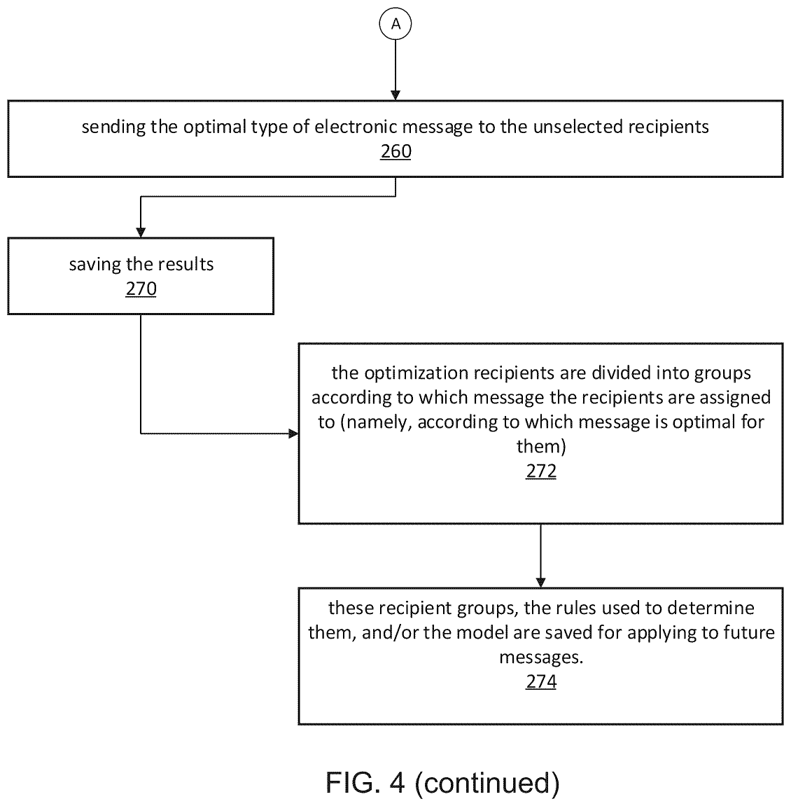

FIG. 4 is a more detailed flowchart of a process 200 for optimizing assignment of electronic message recipients, according to one or more embodiments of the present invention.

Step 210 states to receive a plurality of types of electronic messages, a set of message recipients, and optimization parameters including recipient target behaviors the user desires to optimize. This step can be carried out as described above with reference to steps 110 and 130 of FIGS. 2-3.

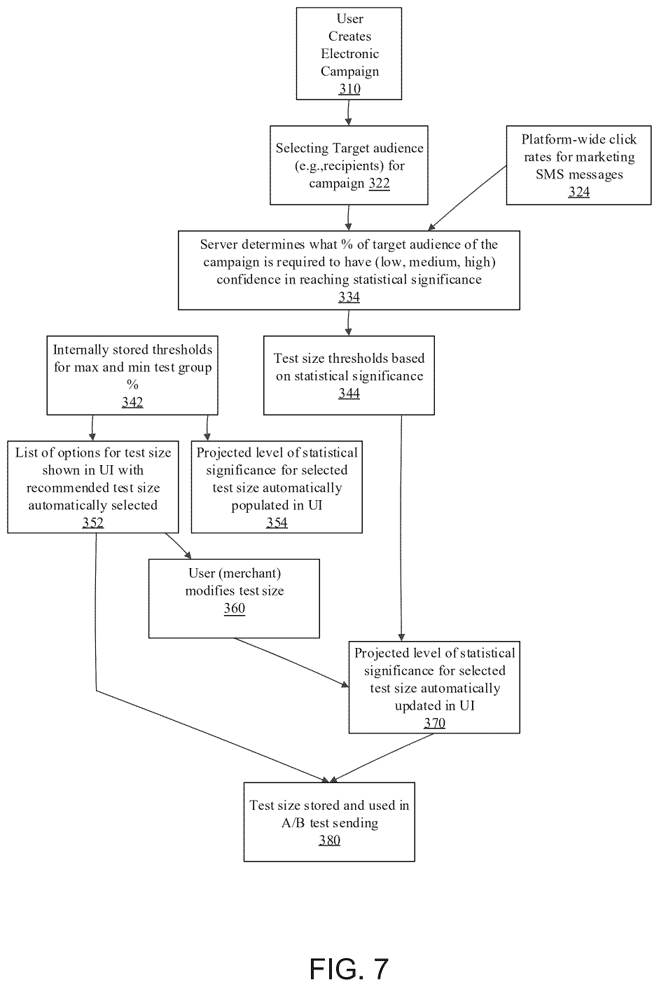

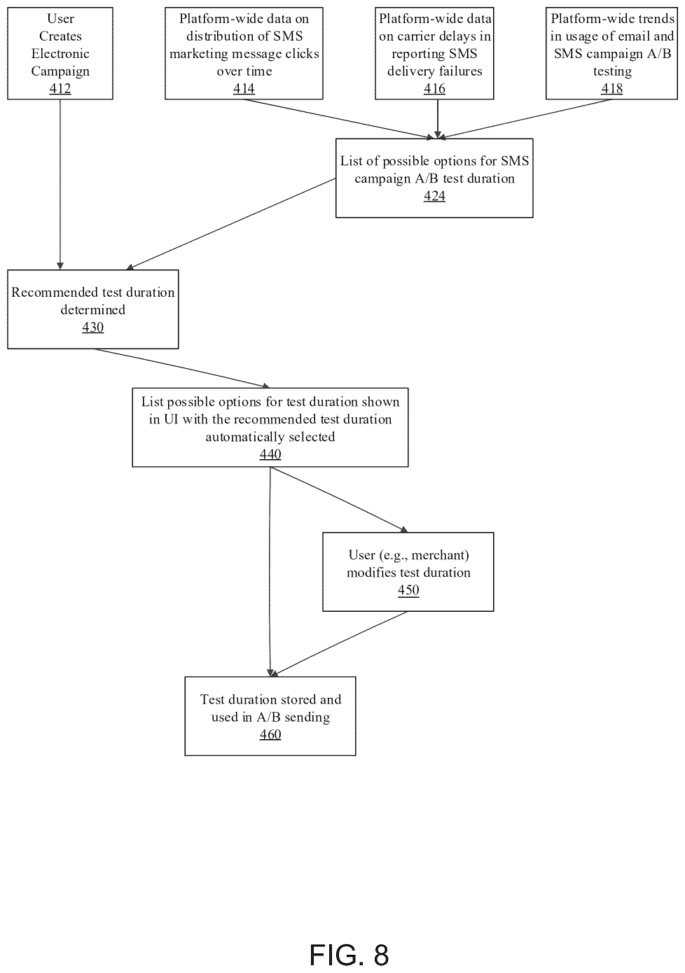

Optionally, in embodiments, the initial input is preprocessed prior to sending it to testing. For example, as discussed further herein in connection with FIGS. 7-8, test size and test duration respectively, can be automatically computed based on various parameters including platform wide trends, initially selected recipients, and historical thresholds. This information can be automatically used or selected for the testing, presented with possible options to the user, and modified by the user.

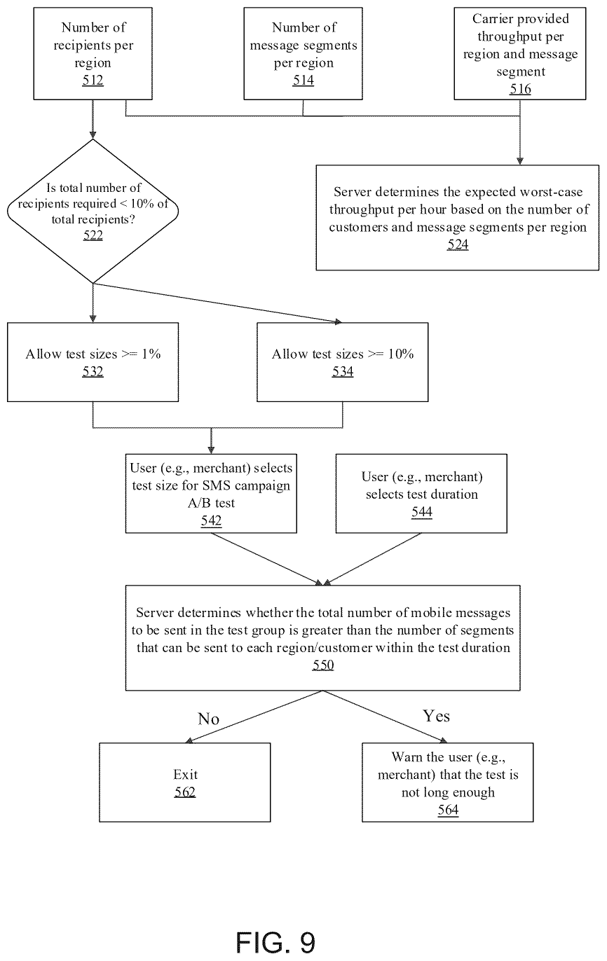

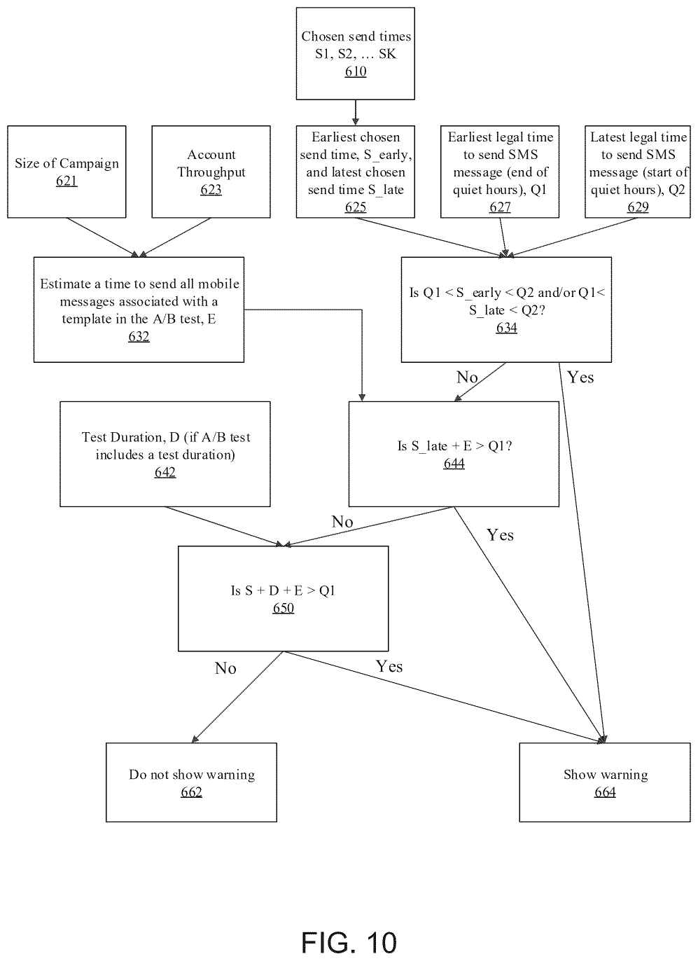

Additionally, in embodiments, the system 10 can provide guidance to the user regarding the input information. For example, as discussed further herein in connection with FIGS. 9-10, the system can provide warnings to the user regarding the test duration and acceptable send times, respectively, allowing the input parameters to be adaptively modified based on thresholds or warnings.

With reference again to FIG. 4, step 220 collectively represents multiple sub-steps for performing testing and evaluation of the different electronic message templates for multiple recipients.

Step 222 states to select a sample of recipients from the set of message recipients. In embodiments, a backend server is programmed to randomly select a sample of the recipients. The number of recipients (or test size) can be determined as described herein. However, in other embodiments, the recipients for the test are selected using historical data or rules to test a particular set of recipients having a property or characteristic the user seeks to interrogate. For example, recipients may be sampled with profile category strata so that a fixed number of recipients in a recency, frequency, monetary (RFM) group “Champions” is sampled.

Step 224 states to send selected electronic messages from the plurality of types of electronic messages to the selected recipients. This step may be administered by the backend server or in combination with the user or another third party such as a bulk email service provider. In some embodiments, where different recipients in the testing are assigned to message template variations, step 224 sends the message template variations according to the assigned recipients.

Step 226 states detecting the target behavior of the selected recipients. This step may be performed as described herein. For example, the user or a third party may collect data of clicks, opens, or purchases responsive to the message within a period of time. This data can be collected by the backend server or stored in another database accessible by the backend server.

Step 228 states to compute a metric corresponding to the target behavior of the selected recipients based on the detecting step. Examples of metrics to compute include, without limitation, click rates, open rates, and purchase rates. In embodiments, the server performs this step. In some embodiments, this information is computed in a database or, for example, an online analytical processing (OLAP) database and the server obtains the information by a request.

Step 240 states to build a recipient assignment model based on the computed metric. In embodiments, step 240 is performed by the backend server after the time delay or test duration described above. In embodiments the recipient assignment model is based on matching particular recipients to particular electronic message templates based on a statistical meaningful success rate the recipient will perform the target behavior over random chance or another electronic message.

An example of a suitable assignment recipient model is a learned decision tree-based model, optionally, the uplift random forest.

In embodiments, the model is trained based on the results from step 220 to identify which recipients are most likely to perform the target behavior in response to receiving the different email templates (A or B).

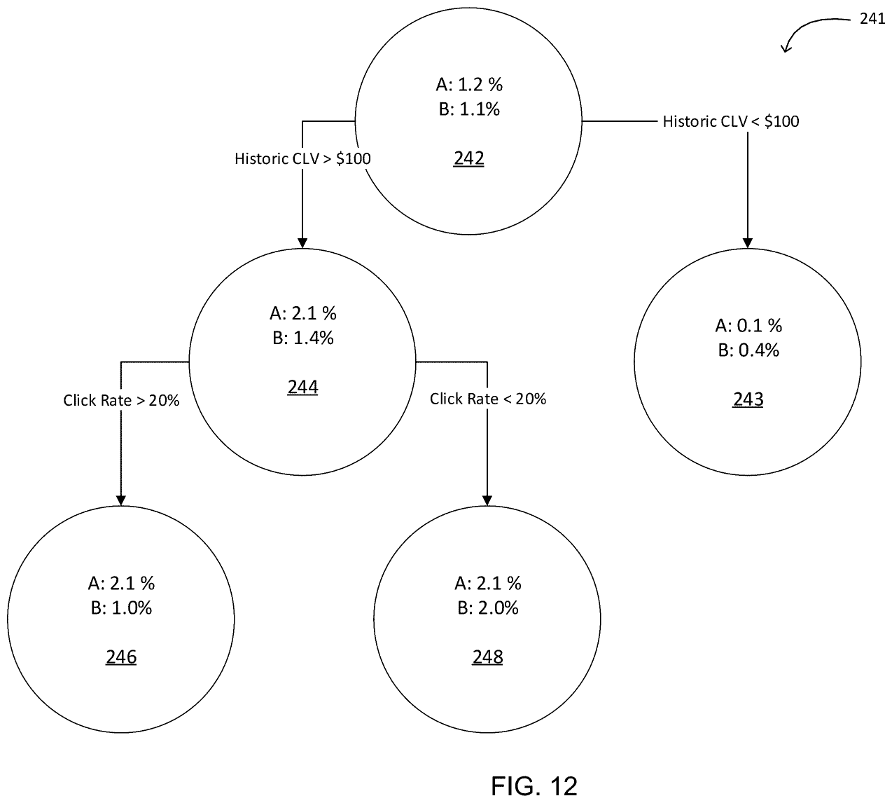

For example, and with reference to FIG. 12, a decision tree 241 is shown for message variations A/B for all sampled recipients.

Top node 242 shows the measured configured metric (for example click rate) was 1.2% for all of the recipients to receive template A and 1.1% for the recipients to receive template B.

Intermediate nodes 243 and 244 are split based on the property or characteristic, namely, whether the recipients' historic customer lifetime value (CLV) is less than or greater than $100, respectively.

Node 243 shows the results for the recipients having a CLV less than $100 for template A: 0.1% and template B: 0.4%.

Node 244 shows the results for the recipients having a CLV greater than $100 for template A: 2.1% and template B: 1.4%.

End nodes 246 and 248 are split based on whether all the recipients having a CLV greater than $100 have a click rate on past messages greater than or less than 20%, respectively.

Node 246 shows the results for the recipients having a CLV greater than $100 and a click rate greater than 20% for template A: 2.1% and template B: 1.0%.

Node 248 shows the results for the recipients having a CLV greater than $100 and a click rate less than 20% for template A: 2.1% and template B: 2.0%.

In this example, it can be seen that the properties of the splits leading to node 248 result in recipient subgroups that have differing preferences for the two variations. Indeed, in the overall population, template A is slightly preferred (1.2%−1.1%=0.1% higher click rate), but for the subgroup indicated by node 244 A is greatly preferred (2.1%−1.4%=0.7% higher click rate) and for the subgroup indicated by the node 243 B is preferred (0.4%−0.1%=0.3% higher click rate). As a result, targeting messages based on the subgroups results in higher overall engagement. For example, a future template similar to template B, could be assigned recipients corresponding to the properties and characteristics of node 243.

Additionally, although only 3 levels and two splits are shown in the decision tree of FIG. 12, the invention can include decision trees not so limited. In embodiments, more or less levels, branches, and nodes may be implemented to build a model to predict optimum recipients for each of the template variations. As described herein, during model training, the splitting continues until a threshold is reached.

In embodiments, during the model training, the recipients and corresponding data are sampled with replacement into data sets of size equal to the original dataset (bootstrap sampling). This sampling is performed at least 2 times. In embodiments, the sampling is performed 100 times.

In embodiments, a decision tree is built for each sampling where the data is sampled into two partitions: one used to recursively build the decision tree and one used to populate the tree leaf nodes once the tree is fully built. The benefit of doing this is that the second partition of data results in an unbiased estimate of how likely recipients in each leaf are to perform the configured action. The decision tree algorithm recursively partitions the data into subsets based on the values of input features and model hyperparameters where examples of hyperparameters include without limitation number of trees, number of nodes, minimum impurity, minimum number of recipients receiving each message type, maximum tree depth, and splitting criterion, etc.

During model training, in embodiments, at each recursive splitting, a subset of features is sampled. The splitting of the data is restricted to the subset of features. The benefit of this step is that the trees are less correlated, and the strength of the ensemble is improved.

The splitting criterion is a method for ranking potential ways of partitioning the data in order to maximize homogeneity within the resulting partitions or maximize the heterogeneity between the partitions. An example is the “IDDP” criterion, which quantifies how much more one partition's recipients are to prefer a given treatment to another versus how much another partition's recipients are to prefer that treatment. For example, in FIG. 12, the first split corresponding to historical CLV at $100 would be preferable over another split resulting in less heterogeneity between subgroups (for example a hypothetical geographical split resulting in 2.0% for A vs. 1.6% for B and 0.2% for A vs. 0.3% for B). Another example is the KL-divergence criterion.

In embodiments, the splitting process continues until a stopping criterion (namely, threshold) is met, such as reaching a maximum depth (number of decision branches (variables) in a tree from the root node to the end leaf node), achieving a minimum number of samples in a leaf node (recipient type), or there is no further improvement in impurity reduction in the nodes (i.e., homogeneity is maximized).

In embodiments, the maximum tree depth is determined prior to training by a function of the number of recipients used for training. By doing this, we can choose a tree of appropriate complexity to avoid overfitting. Moreover, the bias of in-sample error estimates is reduced.

Once the decision tree is built, where each recipient belongs to a leaf node, and the likelihood values are based on the number of recipients in each leaf node and the distribution across trees of a recipient's estimated preference for a message relative to other messages, the tree is evaluated and validated using the cleaned dataset for testing.

Examples of evaluation metrics include estimated “counterfactual” click rate for the model decisions on sampled recipients. This is computed by the total number of clicks for recipients that actually received the variation that the model would assign to them divided by the number of recipients that actually received the variation that the model would assign to them. In other embodiments, other estimators may be used. In other embodiments where variations are assigned not uniformly at random to recipients in the sampled recipient set, an inverse propensity estimator is to estimate the “counterfactual” click rate. In embodiments, the performance of the model is compared to a baseline message assignment algorithm, e.g. determining a single “one-size-fits-all” winning variation. In embodiments, the variables and inputs and optimization parameters are adjusted until the assignment recipient model is shown to provide an improvement over the baseline message assignment algorithm.

Step 250 states to run the recipient assignment model on the unselected recipients (or holdout recipients) to determine an optimal type of electronic message for each of the unselected recipients. This step may be performed by the backed server.

Step 260 states to send the optimal type of electronic message to the unselected recipients. This step may be administered by the backend server or in combination with the user or another third party such as a bulk email service provider.

Step 270 states to save the results. In embodiments, the results are saved optionally for future use. For example, and with reference to step 272, the optimization recipients are divided into groups according to which message the recipients are assigned (namely, according to which message template and content is optimal for them). The groups are saved for use in a future campaign. For example, the recipients in the saved groups can be re-sent the same (or similar) template in a future campaign.

Step 274 states that the recipient groups computed in step 272, rules used to determine the groups, and/or the recipient assignment model itself are saved for applying to future messages.

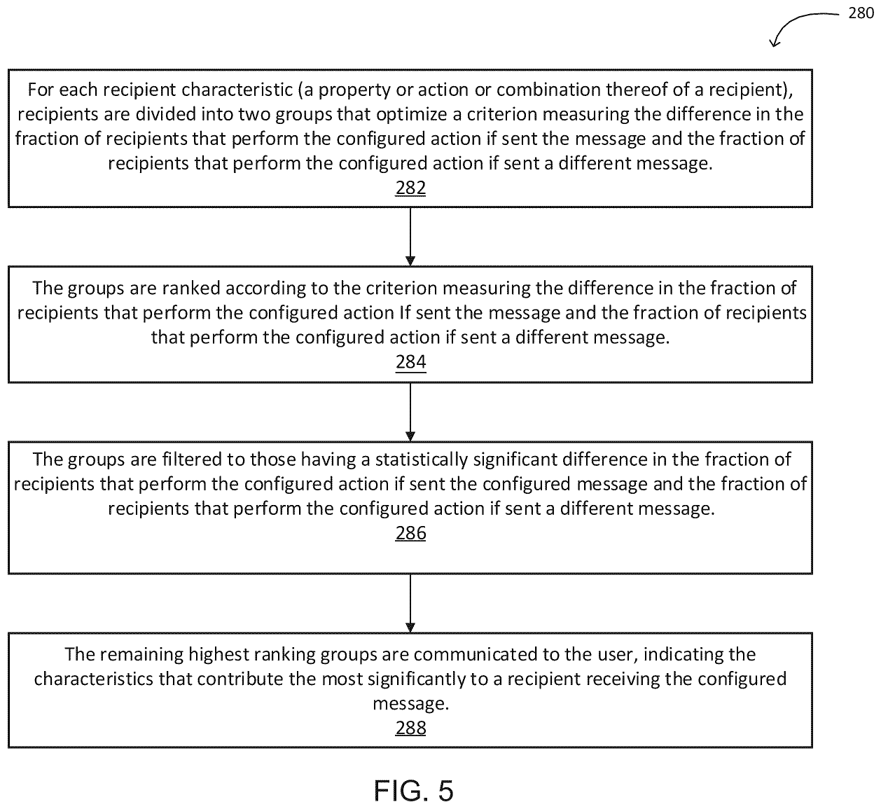

FIG. 5 is a flowchart of a process 280 for computing rules to separate the recipients into different fractions, according to one or more embodiments of the present invention. In embodiments, process 280 is performed by the backend server described above.

Step 282 states, for each recipient characteristic (a property or action or combination thereof of a recipient), to divide the recipients into two groups that optimize a criterion measuring the difference in the fraction of recipients that perform the configured action (e.g., open message) if sent the message and the fraction of recipients that perform the configured action (e.g., open message) if sent a different message.

Step 284 states to rank the groups according to a criterion measuring the difference in the fraction of recipients that perform the configured action if sent the message and the fraction of recipients that perform the configured action if sent a different message.

To illustrate with a prophetic example of 20,000 recipients, where the first message is an advertisement containing a photo of the ocean and the second message contains a photo of the desert, and the characteristic is gender (male), and 400 males open (or predicted to open) the first message (Fraction is 4/10) and 100 males open the different message (Fraction is 1/10). The difference would thus be 3/10. Fractions could be computed for Age (18-20) and Location (Hawaii). The table below sets forth the characteristic, difference in fraction, and is listed according to rank from highest to lowest.

### Example 1

| | | | Difference in |
|---|---|---|---|
| Characteristic | Ocean | Desert | Fraction |
| Male | 400 of 1000 | 100 of 1000 | 3/10 |
| Location Hawaii | 5 of 10 | 4 of 10 | 1/10 |
| Age 18-20 | 50 of 5000 | 49 of 5000 | <0.1 |

Step 286 states to filter the groups to those having a statistically significant difference in the fraction of recipients that perform the configured action if sent the configured message and the fraction of recipients that perform the configured action if sent a different message. For example, Location Hawaii may not be statistically significant because of the small number of recipients. Age 18-20 may also not be statistically significant because of the small difference in the fraction. In embodiments, the result is considered to be statistically significant if the p-value for a corresponding Breslow-Day test is less than a threshold, e.g. 0.02 to 0.1.

### Example 2

| Characteristic | Ocean | Desert |
|---|---|---|
| High CLV | 100 clicks, 1K recipients | 110 clicks, 1K recipients |
| (Customer | (.1 click rate) | (.11 click rate) |
| Lifetime | | |
| Value) Group | | |
| Low CLV Group | 0 clicks, 9K recipients | 890 clicks, 9K recipients |
| Overall | 100 clicks, 10K recipients | 1K clicks, 10K recipients |
| Population | (.01 click rate) | (.1 click rate) |

Logic rules may indicate relative preferences (sometimes embodied as ratios) for a variation compared to the overall recipient population. In Example 2, because the high CLV group has a relatively weaker preference for the Desert variation compared to the overall population (since the relative click rate 0.11/0.1 (110%) is much less than relative click rate 0.1/0.01 (1000%)), a logic rule may be that the High CLV group has an affinity with the Ocean variation. Further, in the above example, by much less, it is meant the relative comparison of 110% to 1000% which is about an 890% difference in preference. In embodiments, logic rules are based on when a relative preference difference exceeds a threshold range such as 800%, and in some embodiments 900%. In embodiments, logic rules are based on when a parameter (e.g., the p-value) of a statistical test (e.g. Breslow Day test or Cochran-Mantel-Haenszel test) performed on the data (namely, contingency tables) determined by the values in Example 2 passes a threshold (e.g. 0.05).

In this scenario, in embodiments, the Desert Variation is sent to all recipients. However, the insight rule that High CLV group have a relatively high preference for the Ocean Variation versus the Overall Population is insightful to a User; and although it may not be actionable in this message campaign, it may be useful for developing hypotheses to test in later campaigns.

Step 288 states to communicate the remaining highest-ranking groups to the user, indicating the characteristics that contribute the most significantly to a recipient receiving the configured message.

To illustrate using the example described above, the “male” and “age” groups would be communicated to the user in connection with the first electronic message template and the target behavior being measured.

This grouping information, message template, sub-user action or behavior, and characteristics being evaluated provide insights into predicting behaviors for recipients based on types of electronic message templates and recipient characteristics. These rules can be used in future to assign recipients to specific types of message templates.

In embodiments, the characteristics, fractions, and ranking are displayed to the user by a graphical user interface. In embodiments, after the information is input, the rankings are automatically computed and displayed in a sequence from highest to lowest or vice versa. In some embodiments, the system computes a chart showing a graphical feature (e.g., bubble, pie slice, or bar) of the chart by relative rank or value.

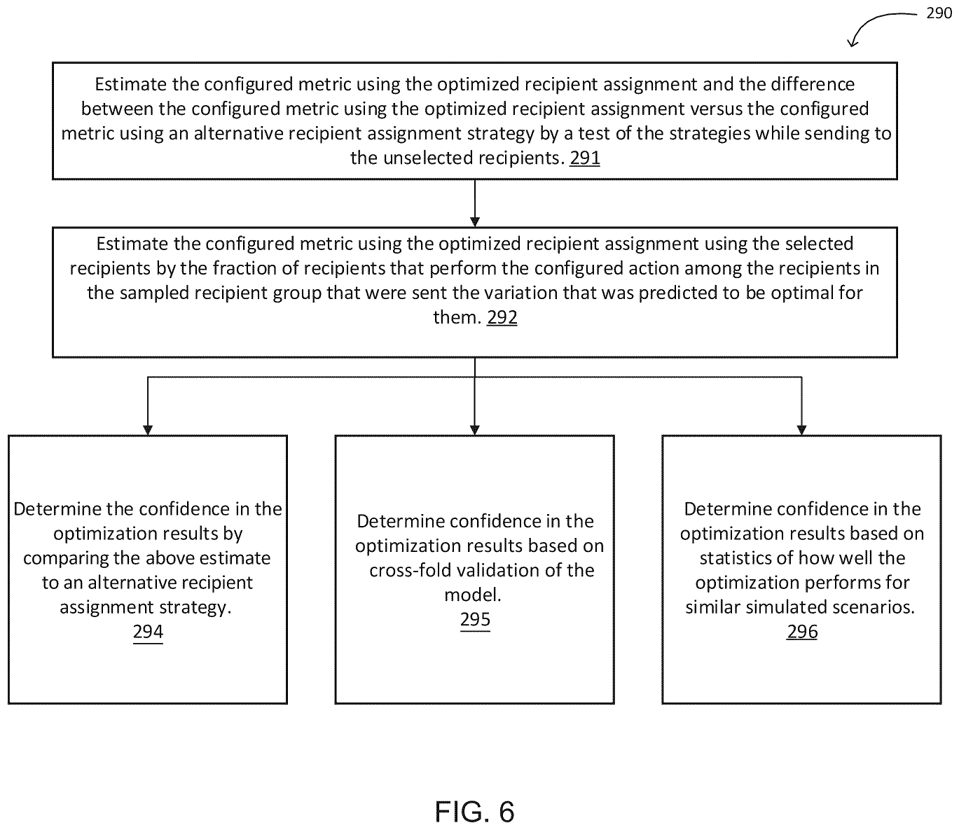

FIG. 6 is a flowchart of a process 290 for computing statistical significance for metrics corresponding to the optimized recipients, according to one or more embodiments of the present invention. In embodiments, process 290 is performed by the backend server described above.

Step 291 states to estimate the configured metric using the optimized recipient assignment and the difference between the configured metric using the optimized recipient assignment versus the configured metric using an alternative recipient assignment strategy (e.g. assigning a single “winner” variation to all recipients) by an “A/B” test of the strategies while sending to the unselected recipients. In embodiments, the confidence in the optimization results can be determined using an A/B testing methodology as described in US Patent Publication No. 20230409821, filed Aug. 27, 2023, entitled “Automated Testing of Templates of a Mobile Message”, to Lawson et al., and US Patent Publication No. 20220414686, filed Nov. 16, 2021, entitled “Automated Testing of Forms”, to Lawson et al., each of which is incorporated by reference in its entirety for all purposes. In embodiments, the confidence in the optimization results is determined using a statistical test. In embodiments, the statistical test is the Fisher Exact test. In embodiments, the statistical test is a z-test for difference in proportions. In embodiments, the statistical test is a permutation test.

Step 292 states to estimate the configured metric using the optimized recipient assignment using the selected recipients by the fraction of recipients that perform the configured action among the recipients in the sampled recipient group that were sent the variation that was predicted to be optimal for them. For example, and with reference to Example 3, shown below, the configured metric (e.g., open rate) of the optimized recipient assignment would be estimated as about 0.427=(400+70)/(1000+100). Example 3:

Variation Received

| Model Assignment | Ocean | Desert |
|---|---|---|
| Ocean | 400 of 1000 | 100 of 1000 |
| Desert | 50 of 100 | 70 of 100 |

Step 294 states to determine the confidence in the optimization results by comparing the above estimate from step 292 to an alternative recipient assignment strategy (e.g. assigning a single “winner” variation to all recipients). For example, with reference again to Example 3 shown above, the open rate of single-winner strategy would be about 0.409=(400+50)/(1000+100). This is indicative that a greater than 4% improvement is achieved by applying the recipient assignments according to the model.

For embodiments, confidence is determined by comparing the estimate with distribution of estimates that could have been achieved without individual-level preferences. For embodiments, this distribution is determined by shuffling response labels within a group that received the same variation. For embodiments, confidence is determined by comparing confidence or credible regions of the metric for each strategy.

Step 295 is another method for determining performance estimates and confidence levels. Step 295 is optional and can be performed in addition to or in lieu of step 294. Per step 295, estimates are based on cross-fold validation of the assignment model on the selected recipients using the estimation method of Step 292. For example, suppose 5-fold cross validation is performed, resulting in 0.4, 0.3, 0.5, 0.35, and 0.45 estimated open rates corresponding to each fold. Then, the estimate is the average (0.4+0.3+0.5+0.35+0.45)/5=0.4. Confidence is determined by the fraction of cross fold estimates are less than some threshold. Suppose the threshold is 0.34. Then confidence is 80%.

Step 296 provides another method for determining confidence levels. Step 296 is optional and can be performed in addition to or in lieu of steps 294, 295. Per step 296, estimates are based on statistics of how well the optimization performs for similar or simulated scenarios. For example, in embodiments, past optimizations with similar test sizes and similar differences between messages are identified. The performance estimate is identified for each of the identified optimizations, as well as the corresponding performance that was observed on the unselected recipient groups. Confidence is then determined as the fraction of identified optimizations that have observed performance higher than a threshold among those with estimated performance approximately equal to the optimization we are estimating confidence for. For embodiments, and with reference to Example 4 below, suppose we estimated an open rate of 0.4 for this optimization. We identified 10 related optimizations with the following statistics. The comparison estimates may be chosen by finding the closest N estimates (where N is a fixed number determined beforehand) or by finding all estimates within X %, e.g. 5-20% of the estimated metric (where X is a fixed number determined beforehand). The estimates of 0.3, 0.4, 0.45, and 0.5 are within 10% of our rate of 0.4. Suppose our threshold is 0.35. Since 3 of the 4 observed estimates are above 0.35, the confidence would be 0.75.

### Example 4

| | | | | | | | | | | |
|---|---|---|---|---|---|---|---|---|---|---|
| Estimated | .1 | .2 | .3 | .4 | .45 | .5 | .6 | .7 | .8 | .9 |
| Observed | .09 | .18 | .31 | .38 | .42 | .48 | .5 | .55 | .34 | .54 |

Note that while Example 4 has only 10 related optimizations for illustrative purposes, datasets could include thousands of related optimizations, thereby increasing the precision of the estimate.

The above technique saves computer resources and increases processing speed by bypassing the need to perform cross-validation or repeated simulations.

FIGS. 7-10 are flowcharts of processes for determining inputs for testing, according to one or more embodiments of the present invention. Although specific reference is made to SMS and mobile message recipients in FIGS. 7-10, it is to be understood that the invention is not so limited and the invention is intended to be applicable to other types of electronic message modalities or channels including without limitation email and push notifications.

FIG. 7 is a flow chart that includes steps of a method for using information from a mobile message campaign, account-level and platform-wide information about mobile message sending patterns and delays in sending, and statistical calculations to suggest a test size for the A/B test, as well as show guidance to the user (e.g., merchant) based on a currently selected test size, according to an embodiment. For embodiments, the currently selected test size may be a default suggested size or a different user-selected size.

A step 310 includes a user 12 (e.g., merchant) creating an electronic campaign. For example, in an embodiment, the electronic campaign is a mobile message campaign. For an embodiment, the server 20 may receive campaign inputs from the user.

A step 322 includes selecting a target audience (e.g., a set of recipients) for the campaign. As previously described, for an embodiment, the selection is made using information about mobile message recipients stored in the server and/or criteria defined by the user (e.g., merchant). For an embodiment, the user (e.g., merchant) selects the mobile message recipients directly. For an embodiment, the user (e.g., merchant) selects groups of mobile message recipients to send the mobile message to and groups of mobile message recipients to exclude from sending. For an embodiment, the user (e.g., merchant) defines criteria and the server automatically determines all mobile message recipients that match those criteria. For an embodiment, the server automatically determines the mobile message recipients based on criteria set by the server and/or the user (e.g., merchant).

A step 324 includes determining platform-wide click rates (customer actions) for marketing SMS messages. For an embodiment, these rates are determined by looking at a large group of marketing mobile messages, potentially informed by information associated with the mobile message templates or the user (e.g., merchant) account and aggregating across them. For an embodiment, the platform-wide click rate is determined by counting the total number of unique clicks on all mobile messages sent by all customers of the platform in the past 30 days and dividing by the total number of mobile messages sent by all customers of the platform in the past 30 days. For an embodiment, the platform-wide click rate is determined by determining all customers of the platform whose mobile message sending volume is within a user-specified threshold of the user (e.g., merchant) account's mobile message sending volume, then performing a calculation similar to the one previously stated. For an embodiment, the platform-wide click rate is determined by determining all mobile messages whose content is similar to the mobile message being sent, based on criteria automatically determined by the server, then performing a calculation similar to the one previously stated.

A step 334 includes the server 20 determining what percentage of the target audience (recipients) of the campaign is required to have (low, medium, high) confidence in reaching a statistical significance. For an embodiment, this is determined based on information associated with the campaign, the platform-wide click rates determined in step 324, user-specified settings, and statistical calculations. For an embodiment, the server uses the platform-wide click rate to perform a statistical power calculation which determines the minimum sample size needed to have a low (e.g. 66%), medium (e.g. 80%), or high (e.g. 90%) threshold of statistical confidence in reaching a statistically significant result, then determines what percentage of the campaign's test size (as calculated in step 322) those thresholds correspond to. For an embodiment, the server uses the platform-wide click rate to perform a statistical power calculation which determines the minimum sample size needed to have a low, medium, or high threshold of statistical confidence in reaching a statistically significant result, where each threshold is inputted by the user (e.g., merchant), then determines what percentage of the campaign's test size (as calculated in step 322) those thresholds correspond to.

A step 344 includes determining test size thresholds based on statistical significance. For an embodiment, this is determined based on the thresholds computed in step 334 and information associated with the campaign. For an embodiment, the test size thresholds based on statistical significance are the nearest whole number to the exact numbers computed in step 324. For an embodiment, the test size thresholds are the nearest whole number to the exact numbers computed in step 324 that lies above and below thresholds specified by the user or determined by the server, e.g. no threshold can result in a test size that is smaller than 5% of the overall number of mobile message recipients or larger than 90% of the overall number of mobile message recipients.

A step 342 includes retrieving internally stored thresholds for maximum and minimum test group percentages.

A step 352 includes listing options for test size shown, for example, in a UI (user interface) with recommended test size automatically selected. For an embodiment, this listing of options is guidance provided to the merchant and is an example of user-specified settings. For an embodiment, a user specifies the percentage of the total number of mobile message recipients that should be included in the test group via entering a percentage between 1 and 100 in a text box or on a slider, and the text box or slider is automatically pre-set to the threshold for high confidence in reaching statistical significance that was retrieved in step 344.

A step 354 includes projecting a level of statistical significance for selected test size automatically populated in the UI. For an embodiment, when the default setting described in step 352 is selected, the UI shows the merchant a message indicating that the A/B test has a high chance of achieving a statistically significant result based on the currently selected test size.

A step 360 includes the user (e.g., merchant) modifying the test size based on the listing options for test size shown.

A step 370 includes a projected level of statistical significance for a selected test size being automatically updated in the UI. For an embodiment, if the user (e.g., merchant) decreases the test size from the automatic setting described in step 352 to the point that it is below the threshold for high confidence computed in step 344, the UI will display that there is now only a medium chance of achieving a statistically significant result based on the currently selected test size, and if they decrease it farther to the point that it is below the threshold for low confidence, the UI will display that there is a now only a low chance of achieving a statistically significant result based on the currently selected test size.

A step 380 includes storing the selected test size and using it in A/B test sending. For an embodiment, once the test size is chosen and saved, it is stored in the server. When the recipients associated with each template are determined at send time, this test size will be used to determine the percentage of the overall mobile message recipients to include in the test group, which will in turn inform the exact mobile message recipients associated with each template.

Without intending to be bound to theory, the Inventors note that for embodiments of the invention the desired level of statistical significance not only increases confidence levels of the result, but also enables building better recipient assignment models and more complex relationships between recipients' characteristics and actions and their preferences.

FIG. 8 is a flow chart that includes steps of a method for using information from a mobile message campaign, account-level and platform-wide information about mobile message sending patterns and delays in sending, and statistical calculations to suggest a test duration for A/B testing of templates, according to an embodiment.

A step 412 includes a user (e.g., merchant) creating an electronic campaign.

A step 414 includes determining platform-wide data on distributions of SMS (e.g., mobile message) marketing message clicks (e.g., customer actions) over time. For an embodiment, this is similar to step 324 except an aggregated measure of the amount of time between the message being received and the message being clicked is additionally determined.

A step 416 includes determining platform-wide data on carrier delays (or, email sender provider delays in the case of email messaging) in reporting SMS delivery failures. For an embodiment, this involves observing the amount of time between when a mobile message is sent and when the mobile carrier reports that an SMS failed to be delivered, then aggregating across many messages similar to step 414. This is largely based on the carrier.

A step 418 includes determining platform-wide trends in usage of email and SMS campaign A/B testing. For an embodiment, this involves looking at the server-generated and user-specified options in many tests. For an embodiment, trends in the time duration selected by users are observed across the platforms to inform the server whether there is a need to add time duration options (e.g. if users are selecting longer and longer options, the server may need to add options that are longer) need to be added. For an embodiment, the additions of time durations are performed dynamically.

A step 424 includes listing possible options for SMS campaign A/B testing duration based on the platform-wide data on distributions of SMS (mobile message) marketing message clicks (customer actions) over time, the platform-wide data on carrier delays in reporting SMS delivery failures, and the platform-wide trends in usage of email and SMS campaign A/B testing.

A step 430 includes determining a recommended test duration. For an embodiment, determining a recommended test duration is based on the information gathered in steps 414, 416, and 418, as well as information associated with the campaign. For an embodiment, the recommended test duration is the smallest whole number of hours larger than the average amount of time it takes for a specified percentage of all mobile message clicks to occur (for example, if 70% of all mobile message clicks occur within 2.5 hours, suggest 3 hours). For an embodiment the recommended duration is the smallest whole number of hours larger than the average amount of time it takes for a specified percentage of all mobile message clicks to occur and also larger than the average amount of time it takes for a specified percentage of failed delivery events to be reported (e.g. if 70% of all mobile message clicks occur within 2.5 hours and 95% of all failed delivery events are reported within 3.3 hours, suggest 4 hours). For an embodiment, the recommended test duration is the closest whole number to the average test duration chosen by users within the past 24 hours.

A step 440 includes list possible options for test durations shown in UI with recommended test duration automatically selected. For an embodiment, the list of possible options for the test durations is included within the guidance given to the marketing manager.

A step 450 includes the user (e.g., merchant) modifying the test duration. For an embodiment, the user (e.g., merchant) modifying the test duration is included within the user-selected configurations.

A step 460 includes storing the test duration and using the test duration in A/B testing of templates.

FIG. 9 is a flow chart that includes steps of a method for providing warnings if the time needed to send the test group for an A/B test is likely to be too long compared to the chosen test duration, according to an embodiment. Such warnings and information are useful when the test group is relatively large or the sending platform has relatively low bandwidth.

A step 512 includes determining a number of recipients per region. For an embodiment, the number of recipients per region is based on information associated with the mobile message templates, including the intended recipients of the mobile message. For an embodiment, the server determines this automatically by looking up information in a database.

A step 514 includes determining a total number of mobile messages to be sent per region. For an embodiment, the total number of mobile messages to be sent is automatically determined by the server based on the content of the message, the information determined in step 512, and knowledge of different rules for the lengths of mobile messages in different regions. (e.g., the exact same text can equal 1 message in the US and 1 message in Canada).

A step 516 includes determining carrier provided throughput per region and message segment. For an embodiment, throughput per region refers to the number of messages it is possible to send in a given time. For an embodiment, step 516 occurs automatically, with the estimated carrier throughput determined by the server based on information about the account (e.g., different accounts can have different types of phone numbers (e.g. short code, toll free, alphanumeric) that have different throughput limits, some accounts may pay a premium for higher throughput allowances) and knowledge of the throughput granted to us by our SMS sending provider (Twilio), which in turn is determined by the throughput provided by the carriers themselves (and therefore can vary by geolocation).

A step 522 includes determining whether the total number of recipients required is greater than a predetermined percentage (such as, 10%) of the total number of recipients.

A step 524 includes the server determining the expected worst-case throughput per hour based on the number of customers and message recipients per region. For an embodiment, this is determined based on the information from steps 512, 514, and 516. For example, the expected worst-case throughput per hour can be calculated by computing the throughput in the scenario where all the mobile messages in the slowest region (i.e. the region with the lowest throughput) are sent before any other messages are sent, then all the mobile messages in the next-slowest region, etc.

A step 532 includes allowing test size of greater or equal to 1% (or another preselected percentage).

A step 534 includes allowing test size of greater or equal to 10%. (or another preselected percentage). It is to be understood that for at least some embodiments, steps 522, 532, and 534 are not necessary, but are included here as a description of an embodiment. For an embodiment, the steps of the method can include proceeding directly from step 512 to step 542.

A step 542 includes the user (e.g., merchant) selecting a test size for the mobile message (SMS) campaign A/B testing.

A step 544 includes the user (e.g., merchant) selecting a test duration for the mobile message (SMS) campaign A/B testing.

A step 550 includes the server determining whether the total number of mobile messages to be sent in the test group is greater than the number of segments that can be sent to each region/customer within the test duration. For an embodiment, this is done by comparing the number of mobile messages that can be sent during the test duration under the worst-case estimate computed in step 524 to the number of mobile messages that need to be sent (which is directly known based on step 542).

A step 562 includes exiting when the number of message segments required to run the test is not greater than the number of segments that can be sent to each region/customer. For an embodiment, this means no warning is surfaced and the user is free to send the test under the current settings.

A step 564 includes warning the user (e.g., merchant) that the test is not long enough when the number of message segments required to run the test is greater than the number of segments that can be sent to each region/customer. For an embodiment, this warning is included within the guidance given to the user/merchant.

FIG. 10 is a flow chart that includes steps of a method for using the information from a mobile message campaign and knowledge of legal regulations about sending marketing mobile messages to provide warnings if any portion of the mobile message campaign is expected to be sent during “quiet hours,” which risks noncompliance with legal regulations, according to an embodiment.

A step 610 includes determining chosen send times S1, S2, . . . . SK of the mobile messages.

A step 621 includes determining the size of the campaign.

A step 623 includes determining an account throughput

A step 625 includes determining the earliest chosen send time (S_early) and the latest chosen send time (S_late).

A step 627 includes determining the earliest legal time to send a mobile (SMS) message (end of quiet hours), Q1.

A step 629 includes determining the latest legal time to send a mobile message (start of quiet hours), Q2.

A step 632 includes estimating a time to send all mobile messages associated with a template in the A/B test, E.

A step 634 includes determining whether Q1 is less than S_early and S_early is less than Q2, and/or whether Q1 is less than S_late and S_late is less than Q2. For an embodiment, this includes determining whether the times that are chosen by themselves violate quiet hours, before taking the time needed to send the mobile messages into account.

If the condition of step 634 is no, then a step 644 includes determining whether S_late+E is greater than Q1. For an embodiment, this includes checking whether the test is expected to send messages during quiet hours after factoring in the time needed to send the mobile messages.

A step 642 includes determining a test duration D is the proposed A/B test includes a test duration.

If the condition of step 644 is no, then a step 650 includes determining whether S+D+E>Q1. For an embodiment, this includes checking whether the test is expected to send messages during quiet hours after factoring in the time needed to send the mobile messages and the time needed to elapse to determine the winner, and to send the winner.

If the condition of step 650 is no, then a step 662 includes a warning not being shown to the user (e.g., merchant). That is, for an embodiment, if no messages are expected to be sent in quiet hours, after considering the times that the mobile messages are scheduled, the amount of time it takes to send the mobile messages, and the amount of time needed to wait to determine the winner of the test and then send the winner. This is an example of guidance being given to the user/merchant via indicating that their settings are valid.

If the condition of either step 634, step 644, or step 650 is yes, then a step 664 includes showing the user (e.g., merchant) a warning. That is, for an embodiment, the warning is shown to the user (e.g., merchant) if any messages are expected to be sent during quiet hours. For an embodiment, the warning is included within the guidance given to the user/merchant.

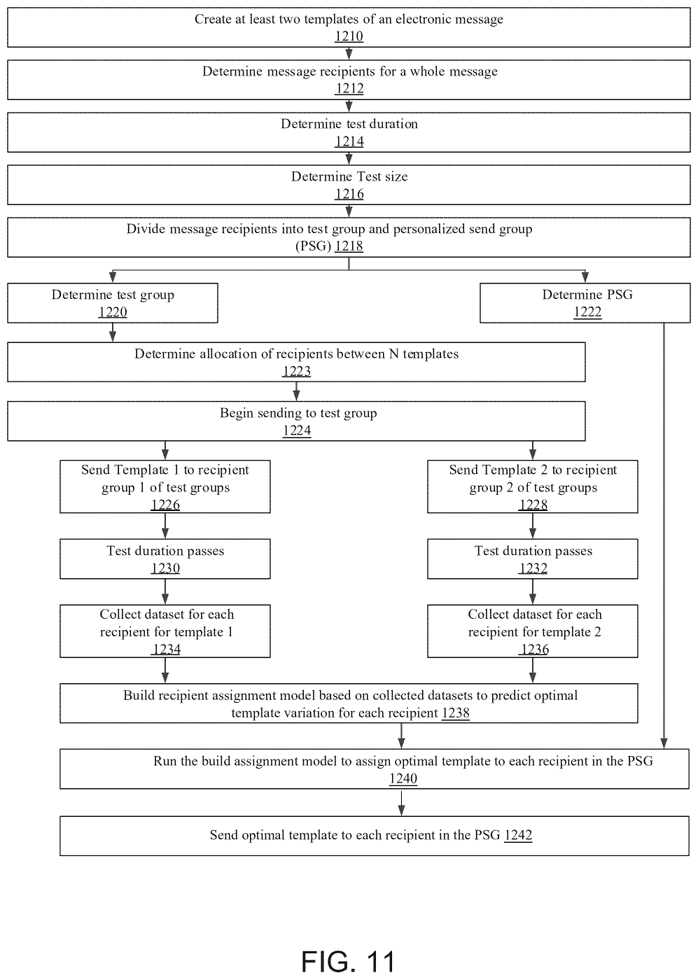

FIG. 11 is a flowchart of a process for sending optimized electronic messages to optimized recipients, according to one or more embodiments of the present invention.

A step 1210 includes creating at least two templates of an electronic message. As previously described, multiple templates are created, wherein each of the templates include a set of data objects that combine to represent a structure of an electronic message. As described, the first and second templates of N templates of the message each have a different content, a different send time, or a different behavior. Accordingly, the set of data objects of each of the first and second templates combine to represent a structure of the electronic message having a different content, send times, and/or different behaviors. For an embodiment, the structure of the electronic message includes the content, the send time, and/or the message behavior. For an embodiment, the templates additional include information pertaining to testing of the message(s). The additional information can include, for example, a test name, a description of test (makes it easier to remember what is being tested), an ending date, and/or specific settings that correspond to statistical significance criteria. For an embodiment, the additional information pertaining to the testing combined with the data for the templates define a test.

A step 1212 includes determining electronic message recipients for a whole message. That is, the list of all planned electronic message recipients is determined.

A step 1214 includes determining a test duration. For an embodiment, the test duration is determined based on one or more of an intended send time of the messages, legal restrictions on send times of messages, a rate of change of data over time in similar tests, and/or a test size. As described above, this user selection can be received after the user is provided with the guidance or warnings.

A step 1216 includes determining a test size. For an embodiment, the test size is determined based on at least one of the intended send time of the messages, the test duration of the messages, the rate of change of data over time for similarly sized tests, the success rate of similar messages, the content, behavior, and/or send times of the templates of the messages included in the testing of the templates. As described above, this is per user selection received after the user is provided with the guidance.

A step 1218 includes dividing the message recipients into a test group 1220 and a holdout or personalized send group (PSG) 1222. For an embodiment, the test group and the PSG are a mutually exclusive groups of message recipients. Further, for an embodiment, the test group and the PSG are an exhaustive (that is, account for the entire group of planned message recipients between the two) division of the planned message recipients. For an embodiment, the test group are selected for testing and determining the optimal templates. For an embodiment, the PSG message recipients then receive messages according to the optimal templates as determined by the testing of the multiple templates.

A step 1223 includes determining the allocation of recipients between N templates (wherein the N templates include at least the first and second templates). For an embodiment, the allocating is random with equal probabilistic distributions within each geographical region that the test is sent. For example, the message may be sent to message recipients from N different geographical regions. For an embodiment, an equal number of messages is sent to each of the geographical regions, but randomly sent to the message recipients within each of the regions. As previously described, for an embodiment, the assigning is deterministic but equally distributed within each of the geographical regions. For example, a first template 1 can be assigned to a first member of the list of planned message recipients, a second template 2 can be assigned to a second member of the list of planned message recipients, and the first template can be assigned to a third member of the list of planned message recipients, and so on.

A step 1224 includes sending the message according to the N templates to the test group.

Steps 1226, 1228 include sending the message according to a template 1 and a template 2 of the N templates to a group 1 of the test group and a group 2 of the test group.

Steps 1230, 1232 include waiting for the determined test duration to pass. During the determined test duration actions of the message recipients are tracked and monitored.

Steps 1234, 1236 include collect dataset comprising actions completed and predictor actions and characteristics for each recipient of the electronic message sent to message recipients of the group 1 and group 2 according to the template 1 and the template 2. For embodiments, the dataset includes determining how many of the message recipients are determined to have performed a task of the message. For an embodiment, the tracked and monitored activities of the electronic message recipients are online activities. For an embodiment, when the electronic modality is SMS, mobile devices of the mobile message recipients are tracked, and the tracked and monitored activities include locations and motions of the mobile message recipients.

A step 1238 includes using the dataset from steps 1234, 1236 and steps from the previously described embodiments to build a recipient assignment model for determining which template has the most statistically advantageous success rate for each recipient (i.e., for determining which template is optimal to generate the targeted behavior for a particular recipient). This step may be performed by the server as described above.

A step 1240 includes running the recipient assignment model of step 1238 to divide the recipients in the PSG into sub-groups corresponding to the predicted best template variation to achieve the targeted recipient behavior.

A step 1242 includes sending each template variation to its corresponding group. As described herein, sending may be performed by the user 12, the operator 18, or a third party such as an integrator 40 or ESP.

For at least some embodiments, the assignment of each of the mobile message recipients is included within information attached to a profile of the mobile message recipient, wherein the information allows actions by the mobile message recipient to be tracked.

At least some embodiments further include integrating information received from the testing with electronic sub-user behavior information. For an embodiment, the electronic sub-user behavior information includes one or more of site visitor actions, discount offers, and product purchases. For an embodiment, integrating information received from the testing with electronic sub-user behavior information comprises using electronic sub-user behavior information to qualify the mobile message recipients for the testing includes ensuring that mobile message recipients in the testing have all taken actions pertaining to a minimum level of actions. For an embodiment, integrating information received from the testing with electronic sub-user behavior information comprises dynamically updating content in the templates based on actions or characteristics of the user within the electronic sub-user behavior information. For an embodiment, integrating information received from the testing with electronic sub-user behavior information includes at least some of the test information determined during testing of the templates being used for influencing sub-user behavior information.

As previously described, for an embodiment, the different content of the first template and the second template includes at least visual representations of a form, including at least one of a size, a text, a layout, a design, colors, or images of the form. For an embodiment, the different content includes images that may increase or decrease likelihood of success due to being more or less engaging. For an embodiment, the different content includes different ways of wording an offer that can change success rates even if the offer itself is not changed. For an embodiment, the different content includes different emojis.

For an embodiment, a different send time of the first template and the second template include a first send time for the first template and a second send time of the second template. For an embodiment, messages received at different times during the day may be more or less likely to achieve success, based on trends observed in both mobile messages and email. That is, mobile message recipient behavior can be observed by prior mobile messages to the mobile message recipient, or other types of electronic mail sent to the mobile message recipient. Based on the recipient's prior behavior, the first and second send times can be selected. Further, there can be legal restrictions on send times, which influence the times the server selects for the first and second send times.

For an embodiment, each of the first template and the second template further include different behavior, wherein the different behavior includes at least one of changes of the mobile messages over time, movement of the mobile messages, or changing color or intensity of the mobile messages. Further, for an embodiment, the different behavior of the first template and the second template includes at least a changing display (such as, changing content, changing color, and/or moving content) on the mobile device of the mobile message recipient.

For an embodiment, at least one of the plurality of mobile devices includes a location sensor and one or more motion sensors, and wherein the at least one of the plurality of mobile devices tracks locations and motions of a recipient of the at least one of the plurality of mobile devices, and the locations and motions of the recipient are included in the collected test data from the testing including the mobile message recipient actions of the first template of the mobile message and the second template of the mobile message.

### Alternative Embodiments

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques.

Indeed, the invention can be applicable to many different electronic messaging modalities or channels including, without limitation, email, mobile messaging, and push notifications. Examples of mobile messaging channels or modalities include, without limitation, SMS, MMS, WAP, as well as mobile messaging services such as WhatsApp, WeChat, Snapchat, or Google Messages.

Additionally, the steps described herein may be implemented in a wide range of configurations whether on one or more processors, one or more servers, a virtual machine, a virtual server, or another type of computing framework or resource programmed and operable to perform the steps as described herein. Steps of the invention may be performed by one computing device or by separate computing devices. The computing devices may be located or arranged together locally or remotely.

Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

What is claimed is:

1. A system comprising at least one server for optimizing assignment of electronic message recipients, the at least one server comprising:
a user-configuration module programmed and operable to receive a plurality of types of electronic messages, a set of recipients, and optimization parameters, wherein the optimization parameters comprise:
a time delay for testing,
a contextual variable corresponding to the recipients, and
a target behavior of the recipient that the user desires to optimize;
a testing module programmed and operable to:
select a sample of recipients from the set of recipients, thereby grouping the recipients into selected recipients and unselected recipients;
send electronic messages from the plurality of types of electronic messages to the selected recipients;
detect, after the time delay for testing, for the target behavior of the selected recipients; and
compute a metric corresponding to the target behavior of the selected recipients based on the detect step;
a build-model module programmed and operable to build a recipient assignment model based on the computed metric, wherein the recipient assignment model is operable to predict the likelihood a recipient shall perform the target behavior after receiving each of the plurality of types of electronic messages and to determine an optimal type of electronic message for each recipient; and
a manage module programmed and operable to:
administer data transfer between the user-configuration, testing, and build-model modules;
run the recipient assignment model on the group of unselected recipients to determine an optimal type of electronic message for each of the unselected recipients; and
send the optimal type of electronic message to each of the unselected recipients or instruct another to send the optimal type of electronic message to each of the unselected recipients.

2. The system of claim 1, wherein the user-configuration module is further operable to receive the sample size for testing.

3. The system of claim 1, wherein the metrics comprise at least one selected from the following: total number of clicks on a link in the message, average dwell time for a message, and message open rates.

4. The system of claim 1, wherein the contextual variables include age, gender, geographical location, number of purchases, or average purchase amount.

5. The system of claim 1, wherein the at least one server is further programmed and operable to compute default parameters for increasing the likelihood of determining the optimal type of electronic message for each recipient.

6. The system of claim 5, wherein the computing comprises use of a lookup table populated with statistics from the recipients or other recipients, a simulation model operable to predict behaviors of the recipients, or an insight rule based on previous historical data or tests from the recipients or other recipients.

7. The system of claim 1, wherein the at least one server is further programmed and operable to compute at least one insight rule, indicating a characteristic of the recipients that contributes to the recipient's affinity towards a type of electronic message.

8. The system of claim 7, during the compute at least one insight rule, the recipients are partitioned into two subgroups comprising: (a) a first subgroup where a criterion measuring the difference in the fraction of recipients that perform the configured action if sent the message and the fraction of recipients that perform the configured action if sent a different message is maximized and (b) a second subgroup that is the remaining recipients, then to rank the groups according to said criterion, and then to determine whether the first and second subgroups' preferences are statistically significantly different than an overall group preferences of recipients using a statistical test.

9. The system of claim 1, wherein the at least one server is further programmed and operable to compute: the likelihood that a recipient shall perform a target behavior for a targeted message is greater than the likelihood that a recipient will perform a target behavior for a general message.

10. The system of claim 1, wherein the recipient assignment model is a decision tree-based algorithm, optionally, uplift random forest model.

11. A computer-implemented method for optimizing assignment of electronic message recipients comprising:
receiving a plurality of types of electronic messages, a set of message recipients, and optimization parameters, wherein the optimization parameters comprise a time delay, contextual variables corresponding to the recipients, and recipient target behaviors the user desires to optimize;
selecting, on a server, a sample of recipients from the set of recipients, thereby defining the recipients into selected recipients and unselected recipients;
sending selected electronic messages from the plurality of types of electronic messages to the selected recipients;
detecting, after the time delay, for the target behavior of the selected recipients;
computing a metric corresponding to the target behavior of the selected recipients based on the detecting step;
building a recipient assignment model based on the computed metric, wherein the recipient assignment model is operable to predict the likelihood a recipient shall perform the target behavior after receiving each of the plurality of types of electronic messages; and
running the recipient assignment model on the unselected recipients to determine an optimal type of electronic message for each of the unselected recipients.

12. The method of claim 11, further comprising computing a set of defaults for increasing the likelihood of determining the optimal type of electronic message for each recipient, and wherein the computing is performed using a lookup table, a simulation model, or insight rule based on historical data of the user or other users.

13. The method of claim 11, wherein the metric is at least one selected from the following: click rates, average dwell time, and open rates.

14. The method of claim 11, wherein the contextual variable is at least one selected from the group comprising age, geographical location, or average purchase amount.

15. The method of claim 11, further comprising computing at least one insight rule, indicating a characteristic of the recipient that contributes to the recipient's affinity towards a type of electronic message.

16. The method of claim 11, further comprising computing (a) the likelihood that a recipient shall perform a target behavior for an optimized message is greater than the likelihood that a recipient will perform a target behavior for a general message; and (b) the likelihood that a recipient shall perform a target behavior for a targeted message is within a predetermined confidence interval.

17. The method of claim 11, further comprising dividing the unselected recipients into groups according to which message the unselected recipients were assigned, and saving the groups, and any rules used to determine the groups.

18. The method of claim 11, further comprising providing guidance if the test delay or number of recipients in the set is not sufficient for obtaining a personalization model with performance higher than a non-personalized message.

19. The method of claim 11, wherein the types of electronic messages differ based on at least one of the following: text size, images, illustrations, format, graphics, and send times.

20. The method of claim 11, further comprising sending to each of the unselected recipients an optimal type of electronic message based on running step.
